(19) United States
(12) Patent Application Publication
(10) Pub. No.: US 2012/0216499 A1
(43) Pub. Date: Aug. 30, 2012

(54) Header for High Biomass Crops

(76) Inventors: Roger Patterson, Winnipeg (CA); Robert Bennett, Winnipeg (CA)

(21) Appl. No.: 13/357,697

(22) Filed: Jan. 25, 2012

Related U.S. Application Data
(60) Provisional application No. 61/437,434, filed on Jan. 28, 2011.

(51) Int. Cl. A01D 43/00

(52) U.S. Cl. 56/181

(57) ABSTRACT

A header designed for tall crops includes a sickle knife for cutting at the ground, an auger behind the knife, a conditioning system at a discharge for forming a swath and a reel with pivotal bat fingers controlled by a linkage which co-operates with a cam of the reel. An upper auger extends across the header parallel to the cutter knife above and in advance of the reel with its flight driving the crop inwardly. Vertically standing sickle knifes extend between the ends of the frame and the upper auger and each includes forwardly extending top and bottom dividers. The conditioning system includes two fluted rollers and a third parallel roller located behind the nip between the fluted rollers so as to engage the material as it emerges from the nip to force the material round the upper roller to further bend the crop material.

This application claims the benefit under 35 USC 119(e) of Provisional Application 61/437434 filed Jan. 28, 2011.

This invention relates to a header designed for very high volume biomass crops developed to maximize crop yield of cellulosic material for bio-fuel production.

### BACKGROUND OF THE INVENTION

New crops are being developed to maximize the biomass yield as part of the program to increase bio-fuel production. Some of the crops selected grow up to 6 meters high with stalks up to 3 cm. in diameter. Sometimes this crop is standing almost vertical and sometimes it is severely lodged and tangled in the same field. The crop that is almost vertical tends to bend slightly in the downwind direction.

Harvest of this crop requires that it be cut down, conditioned and deposited in a windrow with a minimum of dirt content. It must be conditioned so that it can quickly dry from 70 to 80% moisture down to 20% or less so that it can be baled and stored in contact with air without spoiling. Reducing the moisture content also reduces the non-value added mass to be transported thus reducing the transporting costs. The conditioning must also crush or bend the stalks so that they are flexible enough to be easily picked up and baled.

No known production machine can economically harvest this crop. The following problems have been identified with current equipment:

Standing crops may fall down between the rows (30 in spacing) after they are cut and be lost.

Standing crop moves forward and sideways and falls outside the header and is lost.

Existing hay auger headers push standing crop forward until, in some conditions, a root ball is turned up increasing the dirt content in the windrow.

Existing hay auger header dividers push leaning crop down. This in combination with the reel tines push the crop down until it passes under the cutter bar and is lost.

Existing hay auger header reels are designed to move crop across the cutterbar and feed the auger. They are not designed to efficiently pick up down crop.

Existing crop conditioners do not do an adequate job of conditioning this bulky crop.

Existing auger headers tend to feed an excess of crop into the ends of the conditioner rolls. This opens the rolls and causes some stalks to pass through poorly conditioned.

Existing auger headers have insufficient drive torque to handle this crop.

### SUMMARY OF THE INVENTION

It is one object of the present invention to provide header more suitable for harvesting such crops.

According to a first aspect of the invention there is provided an apparatus for harvesting a crop comprising:

a header frame for attachment to a transport vehicle for movement of the header frame over the ground;

a sickle cutter knife across a front edge of the header frame for cutting the crop at or adjacent the ground;

an auger having a flight thereon behind the cutter knife for receiving the cut crop and transporting the cut crop toward a discharge opening at the rear of the frame;

a conditioning system at the discharge opening for conditioning the crop passing through the opening and for forming a swath of the cut conditioned crop for deposit on the ground behind the header frame;

a reel having a plurality of reel bats mounted over the cutter knife and in front of the auger for carrying the crop over the knife for cutting and to the auger;

wherein there is provided an upper auger element extending across the header frame parallel to the cutter knife above and in advance of the reel, the upper auger element including an auger flight on at least part of its length acting to drive the crop in front of the upper auger element inwardly from the sides of the header frame.

Preferably the reel has a plurality of reel bats at spaced positions around the reel axis with each reel bat having a row of axially spaced reel fingers projecting generally outwardly from the reel axis, each bat being mounted for pivotal movement about a bat axis parallel to the reel axis, the angular position of each of the bats about its axis being controlled by a linkage of the bat which co-operates with a cam of the reel so that, as the reel rotates, the linkage moves the bats to a required angular position in dependence upon the co-operation of the linkage with the cam.

Preferably the reel is fixed on the frame.

Preferably the reel remains within a predetermined distance of less than 15 cm from the auger flight.

Preferably the header frame is mounted for tilting movement about a horizontal axis across the header from a first position tilted rearwardly in which the bats of the reel engage the crop in front of and above the knife to a second position tilted forwardly in which the bats of the reel engage the ground in front of the knife.

Preferably the knife is movable forwardly and rearwardly relative to the header frame to cooperate with the tilting movement of the header frame.

Preferably there are provided dividers at the ends of the header frame for separating the crop for cutting wherein the dividers each include a vertically standing sickle knife.

Preferably the height of the vertical sickle knife from the cutter knife is greater than 3 feet and preferably greater than 6 feet.

Preferably there is provided a forwardly projecting divider element at the bottom of the vertical knife for engaging the crop at the bottom of the knife.

Preferably the forwardly projecting divider element at the bottom of the vertical knife includes an upwardly and rearwardly inclined top surface for lifting the crop into the knife.

Preferably there is provided a forwardly projecting divider element at the top of the vertical knife for engaging the crop at the top of the knife.

Preferably the upper auger element extends across between the vertical knives at the top of the knives and parallel to the cutter knife.

Preferably the conditioning system includes a first roller and a second roller, each roller having a generally cylindrical roller surface and a plurality of side by side flutes at angularly spaced positions therearound, the flutes projecting radially outwardly to a flute edge spaced outwardly of the roller surface and extending longitudinally along the roller substantially along the full length thereof, a mounting assembly for mounting the rollers in generally parallel relationship for rotation of each roller about its axis, the mounting assembly mounting the rollers so as to allow relative movement of the second roller relative to the first roller in a direction to increase and decrease spacing between the axes of the rollers from a closed position in which the flutes of the second roller intermesh with the flutes of the first roller to an open position in which the flutes of the rollers are no longer intermeshing, and wherein the conditioning system includes a third roller parallel to the first and second rollers and located behind the nip between the first and second rollers so as to engage the material as it emerges from the nip to force the material round the first roller to further bend the crop material around the flutes of the first roller.

Preferably the third roller also includes a plurality of side by side flutes at angularly spaced positions therearound, the flutes projecting radially outwardly to a flute edge spaced outwardly of the roller surface and extending longitudinally along the roller substantially along the full length thereof.

According to a second aspect of the invention there is provided an apparatus for harvesting a crop comprising:

a header frame for attachment to a transport vehicle for movement of the header frame over the ground;

a sickle cutter knife across a front edge of the header frame for cutting the crop at or adjacent the ground;

an auger behind the cutter knife for receiving the cut crop and transporting the cut crop inwardly toward a center discharge opening at the rear of the frame;

a conditioning system at the discharge opening for conditioning the crop passing through the opening and for forming a swath of the cut conditioned crop for deposit on the ground behind the header frame;

a reel mounted over the cutter knife and in front of the auger for carrying the crop over the knife for cutting and to the auger;

and dividers at the ends of the header frame for separating the crop for cutting;

wherein the dividers each include a vertically standing sickle knife.

Preferably there is provided a forwardly projecting divider element at the bottom of the vertical knife for engaging the crop at the bottom of the knife.

Preferably the forwardly projecting divider element at the bottom of the vertical knife includes an inclined top surface for lifting the crop into the knife.

Preferably there is provided a forwardly projecting divider element at the top of the vertical knife for engaging the crop at the top of the knife.

According to a third aspect of the invention there is provided an apparatus for harvesting a crop comprising:

a header frame for attachment to a transport vehicle for movement of the header frame over the ground;

a sickle cutter knife across a front edge of the header frame for cutting the crop at or adjacent the ground;

an auger behind the cutter knife for receiving the cut crop and transporting the cut crop toward a discharge opening at the rear of the frame;

a conditioning system at the discharge opening for conditioning the crop passing through the opening and for forming a swath of the cut conditioned crop for deposit on the ground behind the header frame;

a reel mounted over the cutter knife and in front of the auger for carrying the crop over the knife for cutting and to the auger;

wherein the conditioning system includes a first roller and a second roller,

each roller having a generally cylindrical roller surface and a plurality of side by side flutes at angularly spaced positions therearound, the flutes projecting radially outwardly to a flute edge spaced outwardly of the roller surface and extending longitudinally along the roller substantially along the full length thereof;

a mounting assembly for mounting the rollers in generally parallel relationship for rotation of each roller about its axis;

the mounting assembly mounting the rollers so as to allow relative movement of the second roller relative to the first roller in a direction to increase and decrease spacing between the axes of the rollers from a closed position in which the flutes of the second roller intermesh with the flutes of the first roller to an open position in which the flutes of the rollers are no longer intermeshing;

and wherein the conditioning system includes a third roller parallel to the first and second rollers and located behind the nip between the first and second rollers so as to engage the material as it emerges from the nip to force the material round the first roller to further bend the crop material around the flutes of the first roller.

Preferably the third roller also includes a plurality of side by side flutes at angularly spaced positions therearound, the flutes projecting radially outwardly to a flute edge spaced outwardly of the roller surface and extending longitudinally along the roller substantially along the full length thereof.

### BRIEF DESCRIPTION OF THE DRAWINGS

One embodiment of the invention will now be described in conjunction with the accompanying drawings in which:

FIG. 1 is a plan view of a header according to the present invention.

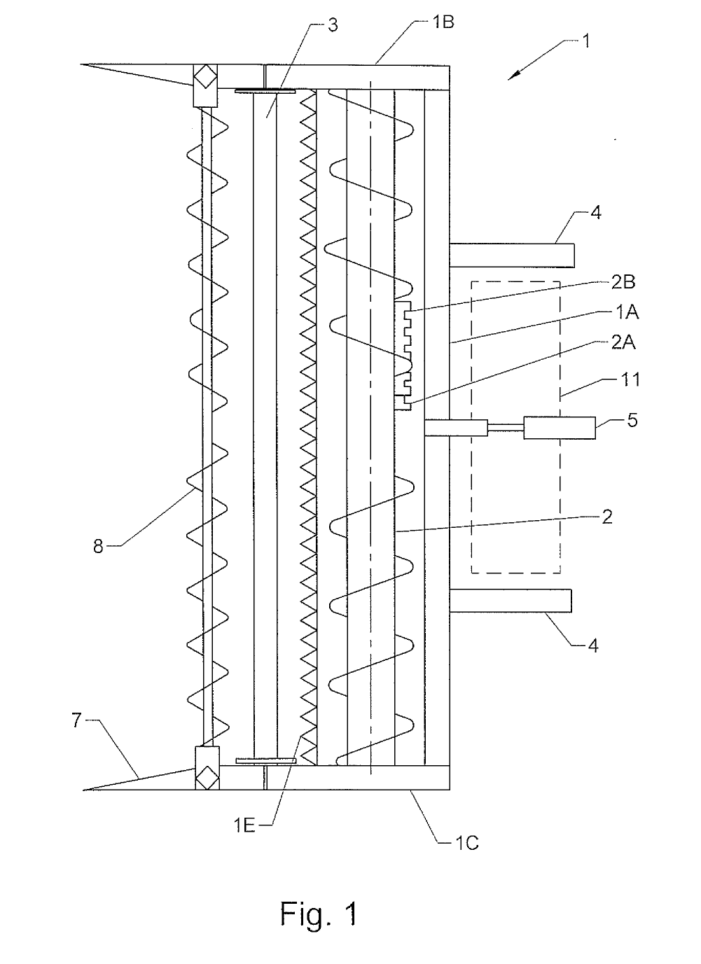

FIG. 2 is a side elevational view of the header of FIG. 1, showing the header frame in a rearwardly titled position with the reel above the sickle knife.

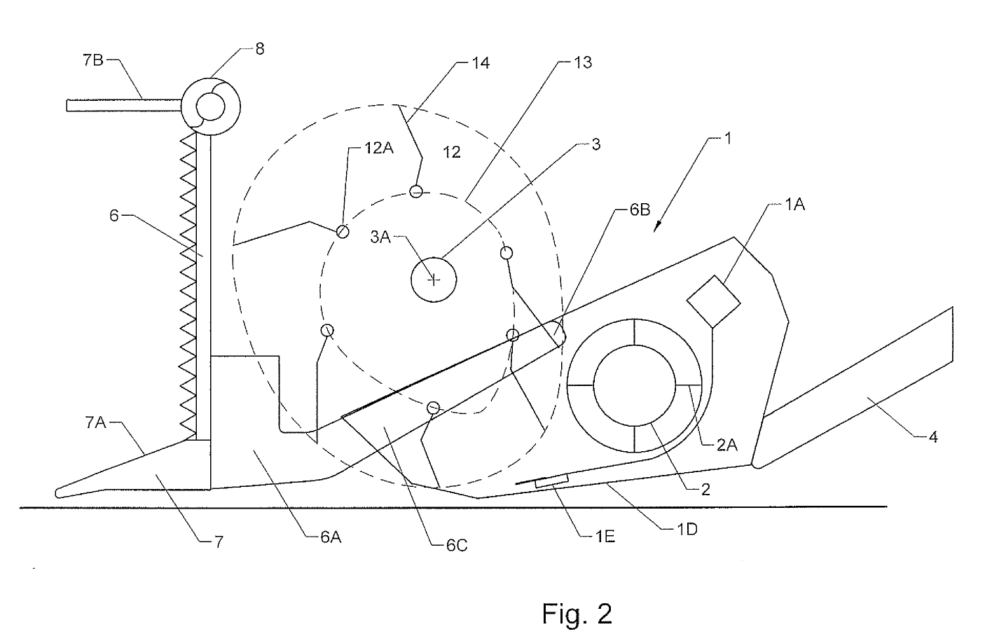

FIG. 3 is a side elevational view of the header of FIG. 1, showing the header frame in a forwardly titled position with the reel reaching the ground forwardly of the sickle knife.

FIG. 4 is a side elevational view of the header of FIG. 1, showing only the reel, knife and auger cooperating to engage the very tall crop.

FIG. 5 is a side elevational view of the conditioner only of the header of FIG. 1.

In the drawings like characters of reference indicate corresponding parts in the different figures.

### DETAILED DESCRIPTION

Headers of this general type are manufactured by the present assignees and contain many details well known to a person skilled in this art to which reference may be made for further details of machines of this type.

In addition, U.S. Pat. No. 7,188,461 (Fox) assigned to the present assignee and issued Mar. 13, 2007 discloses a reel of a type suitable for the current application, the disclosure of which is incorporated herein by reference or which may be referred to for further details not described herein.

In addition U.S. Pat. No. 6,591,598 (Rheal) assigned to the present assignee and issued Jul. 15, 2003 discloses a conditioner of a type suitable for the current application, the disclosure of which is incorporated herein by reference or which may be referred to for further details not described herein.

Turning now to the arrangement shown in the Figures, the conventional auger frame 1 consisting of a frame tube 1A, with major parts, end panels 1B and 1C, pan 1D cutterbar 1E. The auger 2 with feeding fingers 2A or feed panel 2B is generally conventional and feeds to a discharge opening with a conditioner 11 behind the opening.

The reel 3 is similar to the type normally used on a draper header as described in the reference above and is optimized to efficiently pick up down crop. Thus the reel has a plurality of reel bats 12 at spaced positions around the reel axis 3A with each reel bat 12 having a row of axially spaced reel fingers 14 projecting generally outwardly from the reel axis 3A. Each bat 12 is mounted for pivotal movement about a bat axis 12A parallel to the reel axis, the angular position of each of the bats about its axis being controlled by a linkage of the bat which co-operates with a cam 13 of the reel so that, as the reel rotates, the linkage moves the bats to a required angular position which changes around the reel axis 3A as shown in dependence upon the co-operation of the linkage with the cam.

This is modified from the normal draper reel in that the fingers are heavier and longer to handle the thicker stems and the drive system provides about four times the power per ft of reel.

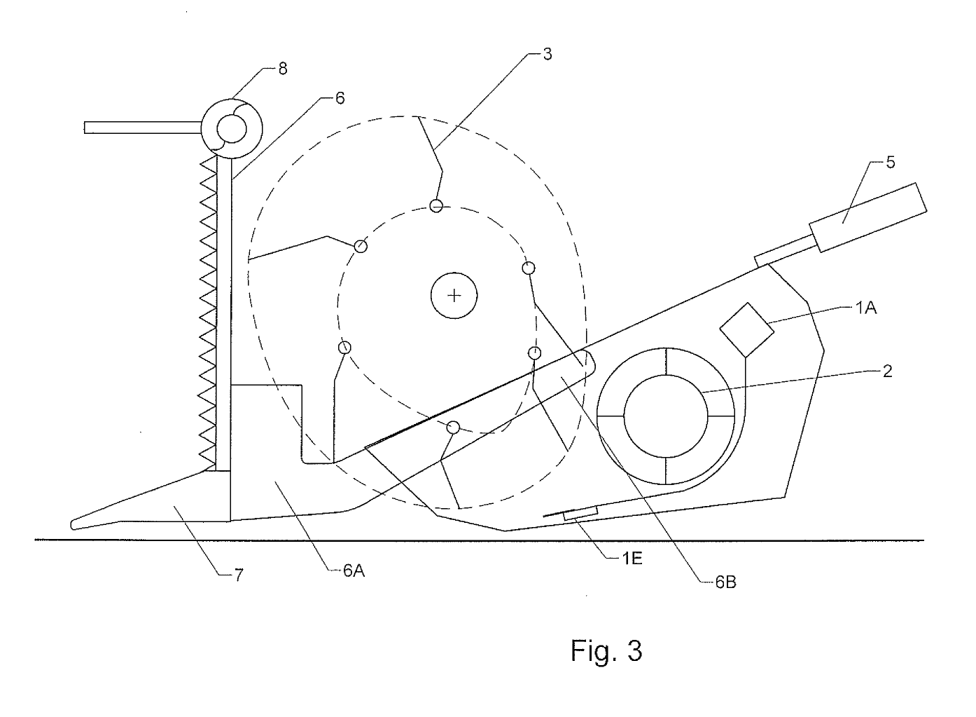

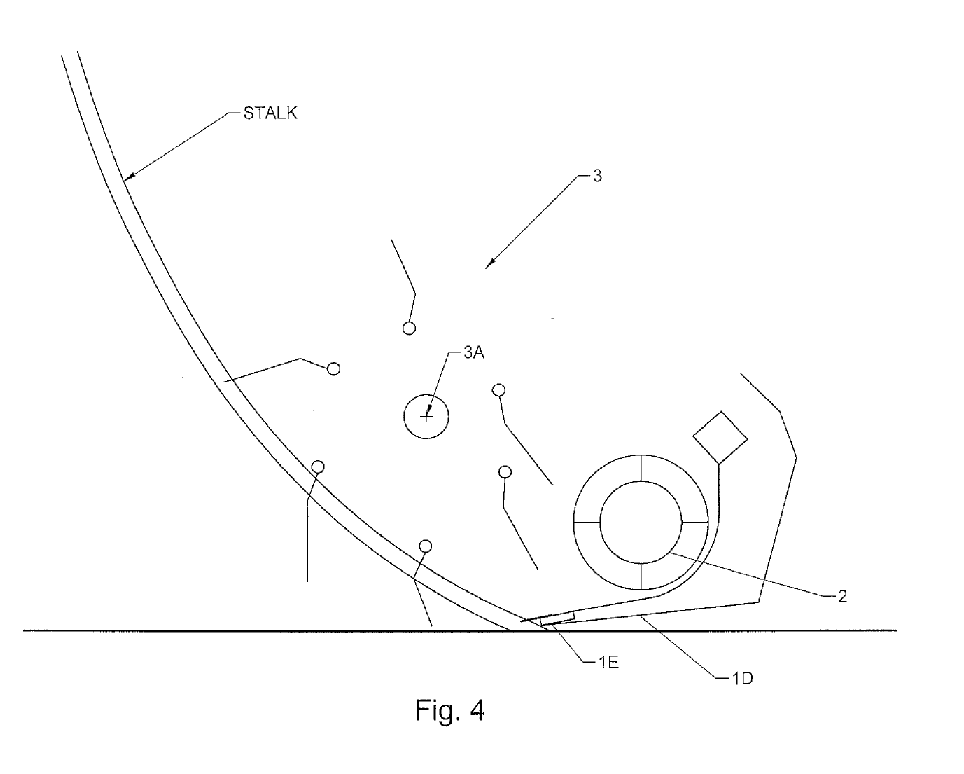

The header is supported by two lower arms 4 from the tractor and a center top link consisting of a hydraulic cylinder 5. The cylinder provides for about twice as much angle change as the standard auger header to allow to tilt as described hereinafter. When the cylinder is extended the header angle is the steepest and the reel fingers touch the ground so they can pick up down crop as shown in FIG. 3. However, with the reel in this position, if the crop is standing, the reel will tip it forward and bend the stalk at a sharp angle before it is cut at the cutterbar. This steep angle may break the crop or pull the roots out of the ground as shown in FIG. 4. Therefore for use in standing crop, the top link cylinder 5 is retracted so that the reel is moved upwardly and rearwardly to a position above the knife so that the crop is bent to a smaller angle.

At the front of each end panel there is a vertical knife 6 about 2 meters (6 feet) tall and typically greater than 3 feet. These have a hydraulic drive at the bottom 6a. These need sufficient power to cut through the 3 cm diameter stalks. At the bottom of the vertical knife is a floating cone divider 7 which projects forwardly from the bottom of the vertical knife. Its function is to lift the down crop up along its inclined top surface 7A to the active part of the knife so the stalks inside the divider may be cut off and fed into the header while stalks outside the divider are discarded for the next pass. The down stalk may extend 4 m into the crop and then turn up and grow through the crop mat. This makes it impossible to pull the crop in as is done with other crops. The vertical knives are mounted on arms 6C carried in a pivot 6b on the end sheet in order to keep the divider cone in contact with the ground when the header is tilted through its full range of angle. The arms 6C may float in this pivot or be actively controlled in their position by being pivoted by a hydraulic cylinder.

There is provided a forwardly projecting divider element 7B at the top of the vertical knife for engaging the crop at the top of the knife.

An auger 8 is mounted above and forward of the reel. It is shown mounted between the top of the vertical knives. It has left and right hand flighting and is rotated so that standing crop is moved inwardly so that it tends to be leaned towards the center of the header before the reel fingers engage the crop. The reel fingers will further increase the lean angle of the crop if it is leaned away from vertical when the reel fingers engage the crop. This has several important benefits. Crop will be leaned in towards the center of the header and thus it will not lean out over the divider and be lost. The crops concerned are typically planted as row crops so that in the harvesting header, the leaned row will be moved over in front of the next adjacent row. This row will support the first leaning row so that stalks will not fall in between the rows and be lost. The stalks will also be entering the header at a small angle. This ensures the reel fingers contact the stalks and improves their ability to feed the crop into the auger. The crop is leaned into the center from both sides. This increases the amount of crop in the center of the conditioner rolls and compensates for the normal tendency of crop to be concentrated at the ends of the conditioner roll. This improves conditioning.

Firstly, the reel is modified relative to conventional reels for auger headers in that the reel has a plurality of reel bats 12 at spaced positions around the reel axis 3A with each reel bat having a row of axially spaced reel fingers 14 projecting generally outwardly from the reel axis; and each bat is mounted for pivotal movement about a bat axis 12A parallel to the reel axis, the angular position of each of the bats about its axis being controlled by a linkage of the bat which co-operates with a cam of the reel so that, as the reel rotates, the linkage moves the bats to a required angular position in dependence upon the co-operation of the linkage with the cam.

The reel is mounted with its axis 3A at fixed position relative to the header frame so that there is no necessity for pivotal support arms of the type typically using in draper headers. Thus the reel remains within a predetermined distance of less than 15 cm from the auger flight since it is necessary to ensure proper feeding into the to auger.

As explained above, the header frame tilts about a horizontal axis across the header from a first position tilted rearwardly in which the bats of the reel engage the crop in front of and above the knife to a second position tilted forwardly in which the fingers engage the ground in front of the knife.

In a further arrangement (not shown) the knife 1E is movable forwardly and rearwardly on slides driven by cylinders relative to the header frame to cooperate with the tilting movement of the header frame. This assists in preventing the stalks being tilted too far forwardly and breaking the root ball out of the soil by ensuring that the cutting action occurs before this tilting angle is reached.

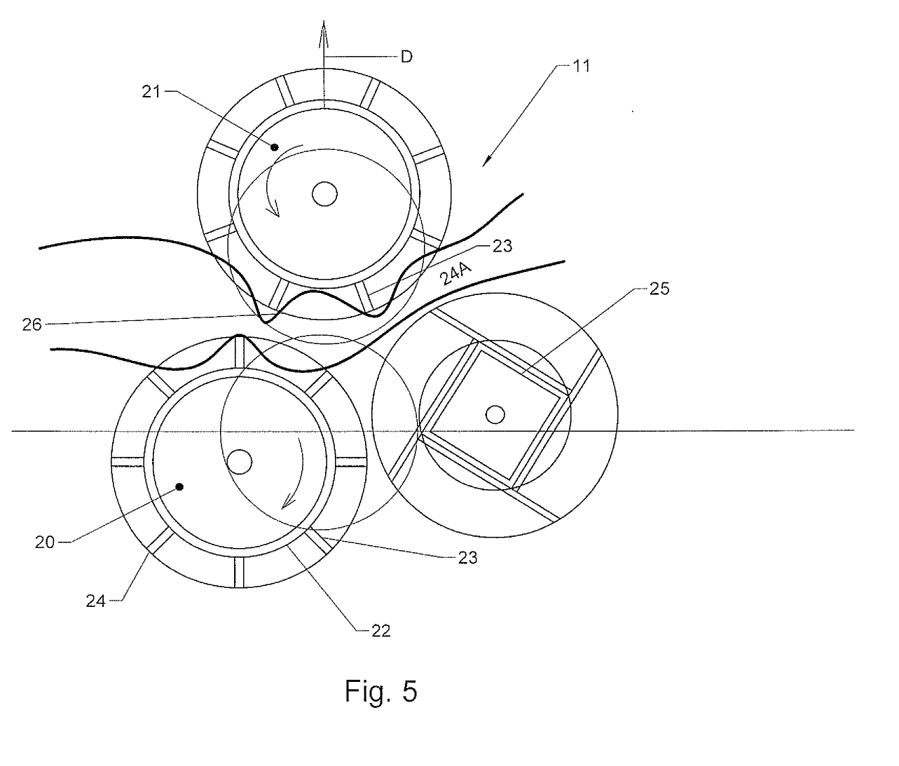

In FIG. 5 is shown a modified conditioner 11. This includes conventional system having a first roller 20 and a second roller 21, where each roller has a generally cylindrical roller surface 22 and a plurality of side by side flutes 23 at angularly spaced positions therearound, the flutes projecting radially outwardly to a flute edge 24 spaced outwardly of the roller surface and extending longitudinally along the roller substantially along the full length thereof. A mounting assembly not shown is provided for mounting the rollers in generally parallel relationship for rotation of each roller about its axis. The mounting assembly mounts the rollers so as to allow relative movement of the second roller 21 generally the top roller relative to the first bottom roller 20 in a direction D to increase and decrease spacing between the axes of the rollers from a closed position in which the flutes of the second roller intermesh with the flutes of the first roller to an open position in which the flutes of the rollers are no longer intermeshing. This conventional system is modified by the addition of a third roller 25 parallel to the first and second rollers and located behind the nip 26 between the first and second rollers so as to engage the material as it emerges from the nip to force the material round the first roller 21 to further bend the crop material around particularly the edge of the closest one of the flutes 23 of the first roller indicated at 24A. This increased bending action occurs preferably without crushing to effect cracking by bending rather than by crushing which requires a high level of power to effect.

Current conditioning rolls work by crushing the crop between the bar and the roll tube or by bending the crop sharply over the edge of the roll. When a thick mat of crop is between the rolls both of these methods are ineffective. If we mount the third roll behind the first two rolls then this arrangement can produce a sharp bending of the crop even when there is a thick mat. This allows the conditioner to maintain conditioning in this high biomass crop.

1. Apparatus for harvesting a crop comprising:
a header frame for attachment to a transport vehicle for movement of the header frame over the ground;
a sickle cutter knife across a front edge of the header frame for cutting the crop at or adjacent the ground;
an auger having a flight thereon behind the cutter knife for receiving the cut crop and transporting the cut crop toward a discharge opening at the rear of the frame;
a conditioning system at the discharge opening for conditioning the crop passing through the opening and for forming a swath of the cut conditioned crop for deposit on the ground behind the header frame;
a reel having a plurality of reel bats mounted over the cutter knife and in front of the auger for carrying the crop over the knife for cutting and to the auger;
wherein there is provided an upper auger element extending across the header frame parallel to the cutter knife above and in advance of the reel, the upper auger element including an auger flight on at least part of its length acting to drive the crop in front of the upper auger element inwardly from the sides of the header frame.

2. The apparatus according to claim 1 wherein the reel has a plurality of reel bats at spaced positions around the reel axis with each reel bat having a row of axially spaced reel fingers projecting generally outwardly from the reel axis, each bat being mounted for pivotal movement about a bat axis parallel to the reel axis, the angular position of each of the bats about its axis being controlled by a linkage of the bat which co-operates with a cam of the reel so that, as the reel rotates, the linkage moves the bats to a required angular position in dependence upon the co-operation of the linkage with the cam.

3. The apparatus according to claim 2 wherein the reel is fixed on the frame.

4. The apparatus according to claim 2 wherein the reel remains within a predetermined distance of less than 15 cm from the auger flight .

5. The apparatus according to claim 1 wherein the header frame is mounted for tilting movement about a horizontal axis across the header from a first position tilted rearwardly in which the bats of the reel engage the crop in front of and above the knife to a second position tilted forwardly in which the bats of the reel engage the ground in front of the knife.

6. The apparatus according to claim 5 wherein the knife is movable forwardly and rearwardly relative to the header frame to cooperate with the tilting movement of the header frame.

7. The apparatus according to claim 1 including dividers at the ends of the header frame for separating the crop for cutting wherein the dividers each include a vertically standing sickle knife.

8. The apparatus according to claim 7 wherein the height of the vertical sickle knife from the cutter knife is greater than 3 feet and preferably greater than 6 feet.

9. The apparatus according to claim 7 wherein there is provided a forwardly projecting divider element at the bottom of the vertical knife for engaging the crop at the bottom of the knife.

10. The apparatus according to claim 9 wherein the forwardly projecting divider element at the bottom of the vertical knife includes an upwardly and rearwardly inclined top surface for lifting the crop into the knife.

11. The apparatus according to claim 7 wherein there is provided a forwardly projecting divider element at the top of the vertical knife for engaging the crop at the top of the knife.

12. The apparatus according to claim 7 wherein the upper auger element extends across between the vertical knives at the top of the knives and parallel to the cutter knife.

13. The apparatus according to claim 1 wherein the conditioning system includes a first roller and a second roller, each roller having a generally cylindrical roller surface and a plurality of side by side flutes at angularly spaced positions therearound, the flutes projecting radially outwardly to a flute edge spaced outwardly of the roller surface and extending longitudinally along the roller substantially along the full length thereof, a mounting assembly for mounting the rollers in generally parallel relationship for rotation of each roller about its axis, the mounting assembly mounting the rollers so as to allow relative movement of the second roller relative to the first roller in a direction to increase and decrease spacing between the axes of the rollers from a closed position in which the flutes of the second roller intermesh with the flutes of the first roller to an open position in which the flutes of the rollers are no longer intermeshing, and wherein the conditioning system includes a third roller parallel to the first and second rollers and located behind the nip between the first and second rollers so as to engage the material as it emerges from the nip to force the material round the first roller to further bend the crop material around the flutes of the first roller.

14. The apparatus according to claim 13 wherein the third roller also includes a plurality of side by side flutes at angularly spaced positions therearound, the flutes projecting radially outwardly to a flute edge spaced outwardly of the roller surface and extending longitudinally along the roller substantially along the full length thereof.

15. Apparatus for harvesting a crop comprising:
a header frame for attachment to a transport vehicle for movement of the header frame over the ground;
a sickle cutter knife across a front edge of the header frame for cutting the crop at or adjacent the ground;
an auger behind the cutter knife for receiving the cut crop and transporting the cut crop inwardly toward a center discharge opening at the rear of the frame;
a conditioning system at the discharge opening for conditioning the crop passing through the opening and for forming a swath of the cut conditioned crop for deposit on the ground behind the header frame;
a reel mounted over the cutter knife and in front of the auger for carrying the crop over the knife for cutting and to the auger;
and dividers at the ends of the header frame for separating the crop for cutting;
wherein the dividers each include a vertically standing sickle knife.

16. The apparatus according to claim 15 wherein there is provided a forwardly projecting divider element at the bottom of the vertical knife for engaging the crop at the bottom of the knife.

17. The apparatus according to claim 15 wherein the forwardly projecting divider element at the bottom of the vertical knife includes an inclined top surface for lifting the crop into the knife.

18. The apparatus according to claim 15 wherein there is provided a forwardly projecting divider element at the top of the vertical knife for engaging the crop at the top of the knife.

19. Apparatus for harvesting a crop comprising:
a header frame for attachment to a transport vehicle for movement of the header frame over the ground;
a sickle cutter knife across a front edge of the header frame for cutting the crop at or adjacent the ground;
an auger behind the cutter knife for receiving the cut crop and transporting the cut crop toward a discharge opening at the rear of the frame;
a conditioning system at the discharge opening for conditioning the crop passing through the opening and for forming a swath of the cut conditioned crop for deposit on the ground behind the header frame;
a reel mounted over the cutter knife and in front of the auger for carrying the crop over the knife for cutting and to the auger;
wherein the conditioning system includes a first roller and a second roller,
each roller having a generally cylindrical roller surface and a plurality of side by side flutes at angularly spaced positions therearound, the flutes projecting radially outwardly to a flute edge spaced outwardly of the roller surface and extending longitudinally along the roller substantially along the full length thereof;
a mounting assembly for mounting the rollers in generally parallel relationship for rotation of each roller about its axis;
the mounting assembly mounting the rollers so as to allow relative movement of the second roller relative to the first roller in a direction to increase and decrease spacing between the axes of the rollers from a closed position in which the flutes of the second roller intermesh with the flutes of the first roller to an open position in which the flutes of the rollers are no longer intermeshing;
and wherein the conditioning system includes a third roller parallel to the first and second rollers and located behind the nip between the first and second rollers so as to engage the material as it emerges from the nip to force the material round the first roller to further bend the crop material around the flutes of the first roller.

20. The apparatus according to claim 19 wherein the third roller also includes a plurality of side by side flutes at angularly spaced positions therearound, the flutes projecting radially outwardly to a flute edge spaced outwardly of the roller surface and extending longitudinally along the roller substantially along the full length thereof.
